(19) United States
(12) Patent Application Publication
(10) Pub. No.: US 2020/0114594 A1
(43) Pub. Date: Apr. 16, 2020

(54) FIBER MOLDED ARTICLE AND METHOD OF MANUFACTURING FIBER MOLDED ARTICLE

(71) Applicant: SEIKO EPSON CORPORATION, Tokyo (JP)

(72) Inventors: Tsukasa OTA, Yamanashi (JP); Kazuhiro ICHIKAWA, Okaya (JP)

(21) Appl. No.: 16/601,665

(22) Filed: Oct. 15, 2019

(30) Foreign Application Priority Data
Oct. 16, 2018 (JP) 2018-195376

(51) Int. Cl. B29C 70/46

(52) U.S. Cl. CPC B29C 70/46

(57) ABSTRACT

A fiber molded article includes a material including fibers and a binder which bonds the fibers together and forms a first structure forming a shape which has a recess where an average drawing depth is 10 mm or more and 150 mm or less, in which a content of the binder in the material is 20% by weight or more and 40% by weight or less. In addition, the average fiber length of the fibers is preferably 0.5 mm or more and 2.0 mm or less.

The present application is based on, and claims priority from JP Application Serial Number 2018-195376, filed Oct. 16, 2018, the disclosure of which is hereby incorporated by reference herein in its entirety.

### BACKGROUND

### 1. Technical Field

The present disclosure relates to a fiber molded article and a method of manufacturing a fiber molded article.

### 2. Related Art

In the related art, press-molding of paper is known as a method of molding paper. For example, Japanese Patent Application Laid-Open No. 2016-141080 discloses molding a sheet of paper into a container having a recess by deep drawing.

In Japanese Patent Application Laid-Open No. 2016-141080, a sheet of paper is press-molded using a lower mold having a recess and an upper mold which enters the recess. Specifically, the paper is arranged on the recess of the lower mold, and pressed such that a projecting portion enters the recess, and the paper is deformed and molded to follow the recess and the projecting portion.

However, depending on the material of the paper, the fiber density of the paper, the drawing depth of the recess, and the like, the paper may be torn or wrinkled during press molding and it is not possible to carry out the molding with high accuracy.

### SUMMARY

The present disclosure is able to be realized as follows.

According to an aspect of the present disclosure, a fiber molded article includes a first structure that is formed of a material including fibers and a binder which bonds the fibers together and that has a shape which has a recess where an average drawing depth is 10 mm or more and 150 mm or less, in which a content of the binder in the material is 20% by weight or more and 40% by weight or less.

According to another aspect of the present disclosure, a method of manufacturing a fiber molded article includes forming a sheet by pressing a web formed of a material including fibers and a binder which bonds the fibers together, in which a content of the binder in the material is 20% by weight or more and 40% by weight or less, and molding a first structure with a shape having a recess with an average drawing depth of 10 mm or more and 150 mm or less, by pressing the sheet at least once.

### BRIEF DESCRIPTION OF THE DRAWINGS

FIG. 1 is a view showing a first embodiment of a manufacturing apparatus and manufacturing steps for carrying out the method of manufacturing a fiber molded article of the present disclosure.

FIG. 2 is a view showing a second embodiment of a manufacturing apparatus and manufacturing steps for carrying out the method of manufacturing a fiber molded article of the present disclosure.

FIG. 3 is a view showing a third embodiment of a manufacturing apparatus and manufacturing steps for carrying out the method of manufacturing a fiber molded article of the present disclosure.

FIG. 4 is a view showing a fourth embodiment of a manufacturing apparatus and manufacturing steps for carrying out the method of manufacturing a fiber molded article of the present disclosure.

FIG. 5 is a view showing a fifth embodiment of a manufacturing apparatus and manufacturing steps for carrying out the method of manufacturing a fiber molded article of the present disclosure.

### DESCRIPTION OF EXEMPLARY EMBODIMENTS

A detailed description will be given of a fiber molded article and a method of manufacturing a fiber molded article of the present disclosure based on preferred embodiments shown in the attached drawings.

### First Embodiment

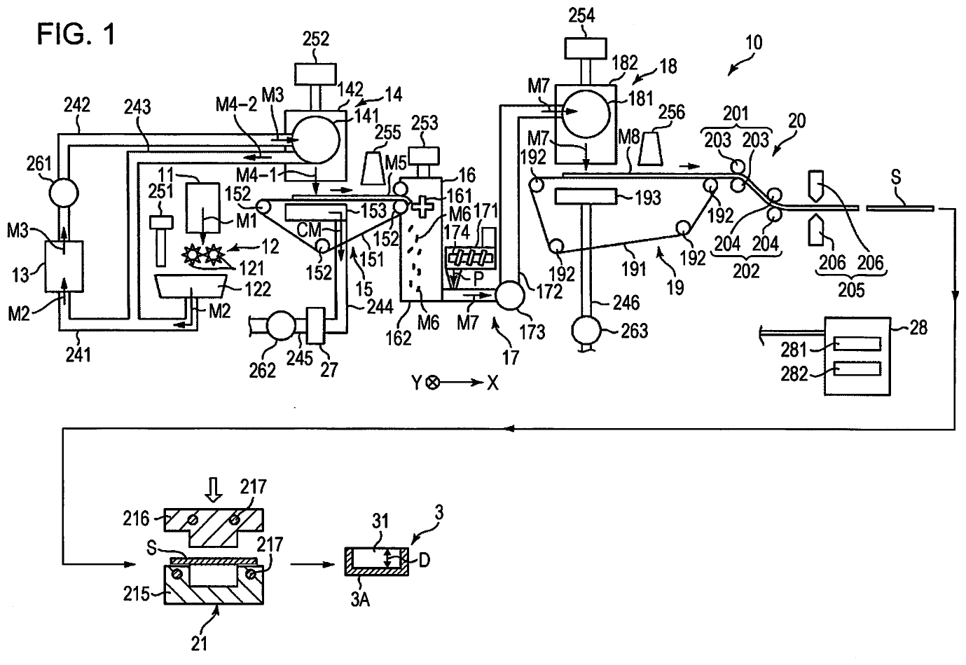

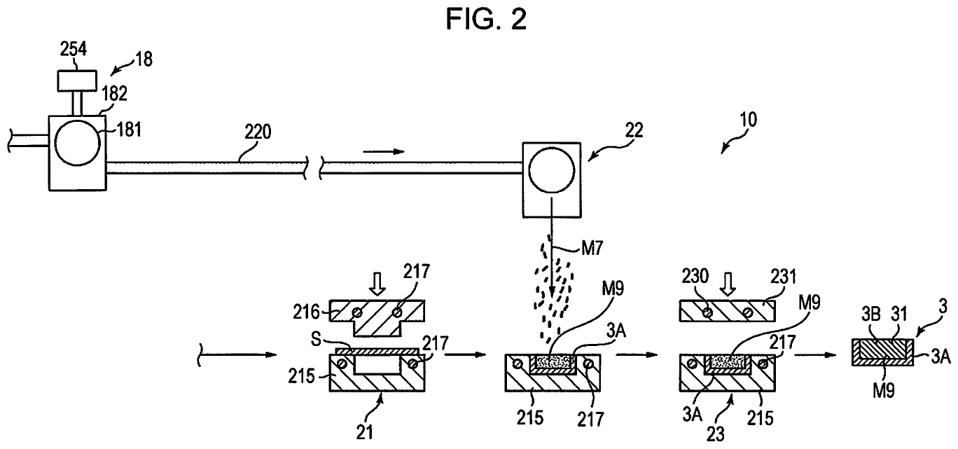

FIG. 1 is a view showing a first embodiment of a manufacturing apparatus and manufacturing steps for carrying out the method of manufacturing a fiber molded article of the present disclosure. Here, for convenience of explanation, the upper side of FIG. 1 is referred to below as “up” or “upper” and the lower side is referred to as “low” or “lower”. The same applies to FIG. 2 to FIG. 5.

First, a description will be given of a fiber molded article 3 manufactured using a fiber molded article manufacturing apparatus 10.

The fiber molded article 3 has a bottomed cylindrical first structure 3A having a recess 31. The recess 31 has an average drawing depth (“D” in FIG. 1) of 10 mm or more and 150 mm or less.

The volume of the recess 31 is not particularly limited, but is preferably, for example, 1 cm³ or more and 1000 cm³ or less, and more preferably 5 cm³ or more and 500 cm³ or less. Due to this, it is possible to house and protect an article.

It is possible to use the first structure 3A, for example, as a container filled with a packing material, a shock absorbing material, or the like. The first structure 3A is formed of a material including fibers and a binder for bonding the fibers together.

Examples of fibers include fibers derived from a plant, fibers derived from animals such as wool, resin fibers such as polyamide, Tetoron, rayon, supra, acetate, vinylon, acrylic, polyethylene terephthalate, and aramid, glass fibers, carbon fibers, and the like, and mixtures of one type or two or more types thereof.

Among the above, the fibers are preferably fibers derived from a plant.

Examples of fibers derived from a plant include cellulose fibers, cotton, linter, kapok, flax, hemp, ramie, silk, and the like, and it is possible to use one type or two or more types of the above in combination; however, among the above, fibers which are mainly cellulose fibers are preferable. Cellulose fibers are easy to obtain and the moldability into the first structure 3A is excellent.

As the cellulose fibers, cellulose fibers derived from wood pulp are preferable. Examples of wood pulps include virgin pulp, kraft pulp, bleached chemi-thermomechanical pulp, synthetic pulp, pulp derived from used paper and recycled paper, and the like, and it is possible to use one type or two or more types of the above in combination. Here, it is sufficient if the cellulose fibers have a fibrous form including, as a main component, cellulose as a compound, that is, cellulose in a narrow sense and correspond to cellulose fibers including hemicellulose and lignin, in addition to cellulose in a narrow sense.

The average fiber length of the fibers is not particularly limited, but is preferably 0.5 mm or more and 2.0 mm or less, and more preferably 0.7 mm or more and 1.8 mm or less. Due to this, bonding is favorably carried out using the binder described below, the moldability is excellent, and appropriate rigidity is obtained after molding.

The average fiber width of the fibers is not particularly limited, but is preferably 5 μm or more and 50 μm or less, and more preferably 7 μm or more and 40 μm or less. Due to this, bonding is favorably carried out using the binder described below, the moldability is excellent, and appropriate rigidity is obtained after molding.

In addition, for the same reason, the average aspect ratio of fibers derived from a plant, that is, the ratio of the average length to the average width is preferably 3 or more and 600 or less, and more preferably 10 or more and 400 or less.

The content of the fibers in the constituent material of the first structure 3A is not particularly limited, but is preferably 50% by weight or more and 80% by weight or less, and more preferably 60% by weight or more and 75% by weight or less. With such a content, it is possible to obtain the first structure 3A which is excellent in moldability into a bottomed cylindrical shape and which is light in weight with sufficient rigidity.

In addition, in the constituent material of the first structure 3A, the content of fibers derived from a plant, in particular, cellulose fibers, in all of the fibers is not particularly limited, but is preferably 60% by weight or more and 100% by weight or less, and more preferably 75% by weight or more and 100% by weight or less.

As the binder for bonding the fibers together, that is, as a bonding resin, it is possible to use any thermoplastic resin or curable resin, but it is preferable to mainly use a thermoplastic resin. Examples of thermoplastic resins include AS resin, ABS resin, polyolefin such as polyethylene, polypropylene, and ethylene-vinyl acetate copolymer (EVA), modified polyolefin, acrylic resin such as polymethyl methacrylate, polyvinyl chloride, polystyrene, polyester such as polyethylene terephthalate and polybutylene terephthalate, polyamides (nylon: registered trademark) such as nylon 6, nylon 46, nylon 66, nylon 610, nylon 612, nylon 11, nylon 12, nylon 6-12, and nylon 6-66, polyamideimide, polyphenylene ether, polyacetal, polyether, polyphenylene oxide, modified polyphenylene ether, polyetheretherketone, polycarbonate, polyphenylene sulfide, thermoplastic polyimide, polyetherimide, liquid crystal polymers such as aromatic polyester, fluorine-based resins such as polytetrafluoroethylene, various thermoplastic elastomers such as styrenes, polyolefins, polyvinyl chlorides, polyurethanes, polyesters, polyamides, polybutadienes, trans polyisoprenes, fluororubbers, and chlorinated polyethylenes, and it is possible to use one type or two or more types of the above in combination. Polyesters or resins including the same are particularly preferable thermoplastic resins. In addition, biomass plastic and biodegradable plastic such as polylactic acid, polycaprolactone, modified starch, polyhydroxybutyrate, polybutylene succinate, and polybutylene succinate adipate may be included. Due to this, the environmental compatibility is improved. In addition, a curable resin such as a thermosetting resin or a photocurable resin may be included. Examples of thermosetting resins include epoxy resins and phenol resins and one type or two or more types thereof may be included.

The form of the binder contained in the constituent material of the first structure 3A is not particularly limited, but the binder is preferably added in the form of particles. In particular, the binder is preferably added as a powder having an average particle diameter of 1 μm or more and 500 μm or less, and more preferably added as a powder having an average particle diameter of 3 μm or more and 400 μm or less. Due to this, the resin is easily dispersed uniformly in the fibers and it is possible to obtain the first structure 3A with no unevenness in rigidity.

In addition, as the average particle diameter of the particles, for example, it is possible to use the particle size Mean Volume Diameter (MVD) of the volume average measured with the laser diffraction type particle size distribution measuring apparatus. In a particle size distribution measuring apparatus using a laser diffraction/scattering method as the measuring principle, that is, a laser diffraction type particle size distribution measuring apparatus, it is possible to measure the particle size distribution on a volume basis.

In the present disclosure, the content of the binder in the constituent material of the first structure 3A is 20% by weight or more and 40% by weight or less. Due to this, the moldability is excellent at the time of manufacturing the bottomed cylindrical first structure 3A which has the recess 31 which has an average drawing depth of 10 mm or more and 150 mm or less. That is, it is possible to prevent wrinkles and tears which occur at the time of molding, while favorably bonding the fibers without unevenness. In addition, the obtained first structure 3A has a sufficient strength and appropriate rigidity.

If the content of the binder in the constituent material of the first structure 3A is excessively small, the bonding of the fibers is insufficient, and it is not possible to prevent wrinkles and tears which occur at the time of molding. On the other hand, when the content of the binder in the constituent material of the first structure 3A is excessively large, while depending on the type of the binder, the rigidity becomes excessively high and wrinkles and tears occur when trying to mold the recess 31 to be relatively deep.

If the content of the binder is in the numerical range described above in the first structure 3A, the moldability is excellent when manufacturing the bottomed cylindrical first structure 3A having the recess 31 having an average drawing depth of 10 mm or more and 150 mm or less; however, the content of the binder in the constituent material of the first structure 3A is more preferably 25% by weight or more and 35% by weight or less. Due to this, it is possible to more reliably obtain the effects of the present disclosure.

In addition, in the constituent material of the first structure 3A, the fibers are preferably randomly arranged, that is, randomly oriented. Here, the random orientation is synonymous with a low degree of orientation. For example, when a sheet manufactured by a wet (wet method) papermaking method is molded by a method as described below, depending on the direction of the orientation of the fibers, there is a possibility that wrinkles or tears may occur during molding, but randomly orienting the fibers makes it possible to more reliably prevent the occurrence of wrinkles or tears at the time of molding.

In order to give the fibers a random orientation in the constituent material of the first structure 3A, it is preferable to manufacture the first structure 3A with a dry method, that is, by dry fiber technology as in the manufacturing method described below. That is, the fibers are preferably fibers based on a defibrated material defibrated by a dry method.

The constituent materials of the first structure 3A may include components other than the fibers and the binder. Examples thereof include the following additives. Examples of additives include neutralizing agents, fixing agents, mucilaginous material, sizing agents, paper strengthening agents, antifoaming agents, water retention agents, water resistance agents, aggregation suppressing agents for suppressing the aggregation of fibers and aggregation of resins, colorants such as carbon black and white pigments, flame retardants, and the like.

The density of the constituent material in the first structure 3A is preferably 0.5 g/cm³ or more and 2.0 g/cm³ or less, and more preferably 0.7 g/cm³ or more and 1.8 g/cm³ or less. Due to this, it is possible to effectively prevent wrinkles and tears from occurring when molding the first structure 3A, and the obtained first structure 3A has a sufficient strength and appropriate impact absorbency and is excellent as a shock absorber.

The average thickness of the first structure 3A is not particularly limited, but is preferably 0.15 mm or more and 2.0 mm or less, and more preferably 0.2 mm or more and 1.7 mm or less. Due to this, the fiber molded article 3 has sufficient rigidity.

In addition, the thickness of the fiber molded article 3 is not limited to a case where the thickness of the fiber molded article 3 is uniform throughout the entire fiber molded article 3 and there may be portions having different thicknesses or portions having gradually changing thicknesses. For example, the bottom portion may be thicker than the side wall portion.

In addition, the shape of the bottom portion of the fiber molded article 3, that is, the shape viewed from the side opposite to the recess 31 is not particularly limited, and may be, for example, circular, oval, triangular, quadrangular, polygonal with more sides, different shapes such as star shaped, or the like. In addition, in a case where the bottom portion of the fiber molded article 3 has a shape having corner portions, the corner portions may be rounded.

In addition, the shape of the bottom surface of the recess 31 in plan view is not particularly limited and is able to be set to a-shape as described above. In addition, the shape above the bottom portion of the fiber molded article 3, that is, the cylindrical portion, is also not particularly limited, and is able to be set to a shape corresponding to the shapes described above.

As described above, the fiber molded article 3 has the first structure 3A that is formed of a material including fibers and a binder for bonding the fibers together and that has a shape having the recess 31 with an average drawing depth of 10 mm or more and 150 mm or less, with the content of the binder in the constituent material being 20% by weight or more and 40% by weight or less. Due to this, it is possible to prevent wrinkles and tears which occur at the time of molding of the first structure 3A, while uniformly bonding the fibers without unevenness. In addition, the obtained first structure 3A has a sufficient strength and appropriate rigidity.

Next, a description will be given of the fiber molded article manufacturing apparatus 10 for performing the method of manufacturing a fiber molded article of the present disclosure.

The fiber molded article manufacturing apparatus 10 shown in FIG. 1 is provided with a raw material supply unit 11, a crushing unit 12, a defibrating unit 13, a sorting unit 14, a first web forming unit 15, a dividing unit 16, a mixing unit 17, a loosening unit 18, a second web forming unit 19, a sheet forming unit 20, and a first molding unit 21. In addition, the fiber molded article manufacturing apparatus 10 is provided with a humidifying unit 251, a humidifying unit 252, a humidifying unit 253, a humidifying unit 254, a humidifying unit 255, a humidifying unit 256, a blower 261, a blower 262, and a blower 263.

In addition, each portion provided in the fiber molded article manufacturing apparatus 10, for example, the raw material supply unit 11, the crushing unit 12, the defibrating unit 13, the sorting unit 14, the first web forming unit 15, the dividing unit 16, the mixing unit 17, the loosening unit 18, the second web forming unit 19, the sheet forming unit 20, the first molding unit 21, and the like are electrically coupled to a control unit 28, respectively. The operation of each of these units is controlled by the control unit 28. The control unit 28 has a central processing unit (CPU) 281 and a storage unit 282. The CPU 281 is able to perform, for example, various types of determinations, various types of instructions, and the like. The storage unit 282 stores, for example, various types of programs such as programs up to the molding of the fiber molded article. In addition, this control unit 28 may be incorporated in the fiber molded article manufacturing apparatus 10, or may be provided in an external apparatus, such as an external computer. In addition, there are cases where the external device communicates with the fiber molded article manufacturing apparatus 10 via a cable or the like, cases using wireless communication, cases using a network such as, for example, the Internet to connect to the fiber molded article manufacturing apparatus 10, and the like. In addition, the CPU 281 and the storage unit 282 may be, for example, integrated and formed as one unit, the CPU 281 may be incorporated in the fiber molded article manufacturing apparatus 10 and the storage unit 282 provided in an external apparatus such as an external computer, or the storage unit 282 may be incorporated in the fiber molded article manufacturing apparatus 10 and the CPU 281 provided in an external apparatus such as an external computer.

In addition, the fiber molded article manufacturing apparatus 10 performs a raw material supply step, a crushing step, a defibrating step, a sorting step, a first web forming step, a dividing step, a mixing step, a loosening step, a second web forming step, a sheet pressure forming step, a cutting step, and a first molding step in this order.

A description will be given below of the configuration of each unit.

The raw material supply unit 11 is a portion which performs the raw material supply step which supplies a raw material M1 (base material) to the crushing unit 12. This raw material M1 is preferably a sheet-like material including the fibers derived from a plant described above, that is, cellulose fibers. In addition, the form of the raw material M1, such as a woven fabric and a nonwoven fabric, does not matter. In addition, the raw material M1 may be, for example, recycled paper (recycled paper) manufactured by defibrating waste paper, or synthetic paper represented by Yupo Paper (registered trademark).

The crushing unit 12 is a portion which performs a crushing step of crushing the raw material M1 supplied from the raw material supply unit 11 in the atmosphere (in the air) or the like. The crushing unit 12 is usually formed of a shredder and has a pair of crushing blades 121 and a chute (hopper) 122.

The pair of crushing blades 121 rotate in the opposite direction to each other to be able to crush, that is, cut, the raw material M1 into coarse fragments M2 (shredded fragments), which are strip-like fragments, therebetween. The shape and size of the coarse fragments M2 are preferably suitable for the defibrating process in the defibrating unit 13, for example, the length of one side is preferably a small piece of 100 mm or less, and more preferably a small piece of 10 mm or more and 70 mm or less.

The chute 122 is arranged below the pair of crushing blades 121 and has, for example, a funnel shape. Due to this, it is possible for the chute 122 to receive the coarse fragments M2 crushed by the crushing blades 121 and dropped.

In addition, above the chute 122, the humidifying unit 251 is arranged adjacent to the pair of crushing blades 121. The humidifying unit 251 humidifies the coarse fragments M2 in the chute 122. The humidifying unit 251 has a filter (not shown), which includes water, and is formed of a vaporization type or warm air vaporization type humidifier which supplies humidified air with increased humidity to the coarse fragments M2 by letting air pass through the filter. Supplying the humidified air to the coarse fragments M2 makes it possible to suppress the coarse fragments M2 from adhering to the chute 122 and the like due to static electricity.

The chute 122 is coupled to the defibrating unit 13 via a pipe 241 which forms a flow path. The coarse fragments M2 collected in the chute 122 pass through the pipe 241 and are transported to the defibrating unit 13.

The defibrating unit 13 is a portion which performs a defibrating step of defibrating the coarse fragments M2 in the air, that is, by a dry method. The defibrating process in the defibrating unit 13 makes it possible to generate defibrated material M3 from the coarse fragments M2. Here, “defibrate” refers to loosening the coarse fragments M2, which are formed by bonding a plurality of fibers, fiber by fiber. The loosened fibers become the defibrated material M3. The shape of the defibrated material M3 is linear or band-like.

For example, in the present embodiment, the defibrating unit 13 is formed of an impeller mill having a rotor rotating at high speed and a liner positioned on the outer periphery of the rotor. The coarse fragments M2 flowing into the defibrating unit 13 are defibrated by being pinched between the rotor and the liner.

In addition, it is possible for the defibrating unit 13 to generate an air flow from the crushing unit 12 to the sorting unit 14 by the rotation of the rotor. Due to this, it is possible to suction the coarse fragments M2 from the pipe 241 to the defibrating unit 13. In addition, after the defibrating process, it is possible to send the defibrated material M3 out to the sorting unit 14 through a pipe 242.

In the middle of the pipe 242, the blower 261 is installed. The blower 261 is an air flow generating apparatus which generates an air flow toward the sorting unit 14. Due to this, transfer of the defibrated material M3 to the sorting unit 14 is promoted.

The sorting unit 14 is a portion which performs a sorting step of sorting the defibrated material M3 according to the size of the length of the fibers. In the sorting unit 14, the defibrated material M3 is sorted into a first sorted material M4-1 and a second sorted material M4-2 larger than the first sorted material M4-1. The fibers in the first sorted material M4-1 have a size suitable for the subsequent manufacturing of a sheet S and the manufacturing of the fiber molded article 3. The values are as described above. On the other hand, the second sorted material M4-2 includes, for example, material having insufficient defibration and material in which the defibrated fibers are excessively aggregated.

The sorting unit 14 has a drum unit 141 and a housing portion 142 for housing the drum unit 141.

The drum unit 141 is a sieve which is formed of a mesh with a cylindrical shape and which rotates around the central axis thereof. The defibrated material M3 flows into the drum unit 141 from the pipe 242. Then, when the drum unit 141 rotates, the defibrated material M3 smaller than the mesh size of the mesh is sorted as the first sorted material M4-1, and the defibrated material M3 of a size which is the mesh size of the mesh or more is sorted as the second sorted material M4-2. Then, the first sorted material M4-1 drops from the drum unit 141.

On the other hand, the second sorted material M4-2 is sent out to a pipe 243 coupled to the drum unit 141. The pipe 243 is coupled to the pipe 241 at the opposite side (downstream side) to the drum unit 141. The second sorted material M4-2 which passed through the pipe 243 joins the coarse fragments M2 in the pipe 241 and flows into the defibrating unit 13 together with the coarse fragments M2. Due to this, the second sorted material M4-2 is returned to the defibrating unit 13 and subjected to a defibration process with the coarse fragments M2.

Selecting the mesh size of the mesh of the drum unit 141 makes it possible to set the size of the fibers in the first sorted material M4-1 passing through the drum unit 141 within a predetermined range. In addition, selecting the mesh size of a mesh belt 151 described below makes it possible to set the size of the fibers in the first sorted material M4-1 passing through the mesh belt 151 within a predetermined range. Performing these selections makes it possible to set the size of the fibers in the constituent material of the fiber molded article 3, in particular, the average fiber length of the fibers, to the appropriate values as described above.

In addition, the first sorted material M4-1 which passed through the drum unit 141 drops while being dispersed in air, and travels to the first web forming unit (separation unit) 15 positioned below the drum unit 141. The first web forming unit 15 is a portion which performs a first web forming step of forming a first web M5 from the first sorted material M4-1. The first web forming unit 15 has a mesh belt (separation belt) 151, three stretching rollers 152, and a suction unit (suction mechanism) 153.

The mesh belt 151 is an endless belt and the first sorted material M4-1 is deposited thereon. The mesh belt 151 is wound around three stretching rollers 152. The stretching rollers 152 are interconnected to a drive unit (not shown) having a driving source such as a motor, a transmission, and the like and are rotationally driven by the driving of the drive unit and the first sorted material M4-1 on the mesh belt 151 is transported to the downstream side.

The first sorted material M4-1 is the size of the opening of the mesh belt 151 or more. Due to this, the passage of the mesh belt 151 is restricted and it is possible to deposit the first sorted material M4-1 on the mesh belt 151. In addition, the first sorted material M4-1 is transported to the downstream side together with the mesh belt 151 while being deposited on the mesh belt 151, thus forming the layered first web M5.

In addition, there is a concern that foreign matter CM, that is, for example, dust, dirt, and the like, may be mixed in the first sorted material M4-1. The foreign matter CM may be generated, for example, by crushing or defibration. Then, such foreign matter CM is recovered by a recovery unit 27 described below.

It is possible for the suction unit 153 to suction air from below the mesh belt 151. Due to this, it is possible to suction the foreign matter CM which passed through the mesh belt 151 together with air.

In addition, the suction unit 153 is coupled to the recovery unit 27 via a pipe 244. The foreign matter CM suctioned by the suction unit 153 is recovered by the recovery unit 27.

A pipe 245 is further coupled to the recovery unit 27. In addition, the blower 262 is installed in the middle of the pipe 245. The operation of the blower 262 makes it possible to generate a suction force in the suction unit 153. Due to this, the formation of the first web M5 on the mesh belt 151 is promoted. The foreign matter CM is removed from the first web M5. In addition, dust and dirt pass through the pipe 244 due to the operation of the blower 262 and reach the recovery unit 27.

The humidifying unit 252 is coupled to the housing portion 142. The humidifying unit 252 is formed of a vaporization type humidifier similar to the humidifying unit 251. Due to this, humidified air is supplied into the housing portion 142. The humidified air makes it possible to humidify the first sorted material M4-1, and thus it is also possible to suppress the first sorted material M4-1 from attaching to the inner wall of the housing portion 142 due to electrostatic force.

The humidifying unit 255 is arranged on the downstream side of the sorting unit 14. The humidifying unit 255 is formed of an ultrasonic humidifier which sprays water. Due to this, it is possible to supply water to the first web M5, and thus to adjust the water content of the first web M5. This adjustment makes it possible to suppress the cling of the first web M5 to the mesh belt 151 due to electrostatic force. Due to this, the first web M5 is easily peeled off from the mesh belt 151 at a position where the mesh belt 151 is folded back by the stretching rollers 152.

The dividing unit 16 is arranged on the downstream side of the humidifying unit 255. The dividing unit 16 is a portion which performs a dividing step of dividing the first web M5 peeled off from the mesh belt 151. The dividing unit 16 has a propeller 161 supported to be able to rotate and a housing portion 162 for housing the propeller 161. Then, it is possible to divide the first web M5 by the rotating propeller 161. The divided first web M5 becomes divided bodies M6. In addition, the divided bodies M6 move down in the housing portion 162.

The humidifying unit 253 is coupled to the housing portion 162. The humidifying unit 253 is formed of a vaporization type humidifier similar to the humidifying unit 251. Due to this, humidified air is supplied into the housing portion 162. The humidified air also makes it possible to suppress the divided bodies M6 from attaching to the propeller 161 and the inner wall of the housing portion 162 due to electrostatic force.

The mixing unit 17 is arranged on the downstream side of the dividing unit 16. The mixing unit 17 is a portion which performs the mixing step of mixing the divided bodies M6 and the resin P. The mixing unit 17 has a resin supply unit 171, a pipe 172, and a blower 173.

The pipe 172 couples the dividing unit 16 with the loosening unit 18 and is a flow path through which a mixture M7 of the divided bodies M6 and the resin P passes.

The resin supply unit 171 is coupled in the middle of the pipe 172. The resin supply unit 171 has a screw feeder 174. Rotating and driving the screw feeder 174 makes it possible to supply the resin P to the pipe 172 as powder or particles. The resin P supplied to the pipe 172 is mixed with the divided bodies M6 to form the mixture M7. Here, the resin P is a binder which bonds the fibers in a subsequent step, and the content, the composition, and the particle size are as described above.

In addition to the resin P, the additives described above may be included as necessary as additives supplied from the resin supply unit 171. The additives may be supplied separately from the resin P or may be supplied from the resin supply unit 171 by being previously included (premixed) in the resin P.

In addition, the blower 173 is installed in the middle of the pipe 172 on the downstream side of the resin supply unit 171. The divided bodies M6 and the resin P are mixed by the action of a rotating portion such as the blades of the blower 173. In addition, it is possible for the blower 173 to generate an air flow toward the loosening unit 18 which performs the next step. Due to this air flow, it is possible to stir and mix the divided bodies M6 and the resin P in the pipe 172. Due to this, it is possible for the mixture M7 to flow into the loosening unit 18 in a state in which the divided bodies M6 and the resin P are uniformly dispersed. In addition, the divided bodies M6 in the mixture M7 are loosened in the process of passing through the pipe 172 and become finer and fibrous.

In addition, adjusting the supply amount of the resin P from the resin supply unit 171 with respect to the divided bodies M6 flowing into the pipe 172 from the dividing unit 16 makes it possible to set the blending ratio of the fibers and resin P in the mixture M7. This setting is possible, for example, by adjusting the rotation speed of the screw feeder 174 under the control of the control unit 28 to adjust the supply amount of the resin P supplied per unit time. Performing such setting makes it possible to set the content of fibers in the constituent material of the fiber molded article 3 or the content of resin to the appropriate values as described above.

The loosening unit 18 is a portion which performs a step of loosening the fibers entangled with each other in the mixture M7. The loosening unit 18 has a drum unit 181 and a housing portion 182 for housing the drum unit 181.

The drum unit 181 is a sieve which is formed of a mesh with a cylindrical shape and which rotates around the central axis thereof. The mixture M7 flows into the drum unit 181. Then, rotating the drum unit 181 makes it possible for fibers and the like in the mixture M7 smaller than the mesh openings of the mesh to pass through the drum unit 181. At that time, the mixture M7 will be loosened.

The drum unit 181 is not limited to the shape of a rotating drum and may be a sieve having mesh openings which vibrate in the in-plane direction, or may be formed to spray the mixture M7 as a spray.

Then, the mixture M7 loosened in the drum unit 181 drops while dispersing in the air and travels to the second web forming unit 19 positioned below the drum unit 181. Accordingly, the fibers are randomly deposited in a state without orientation. The second web forming unit 19 is a portion which performs a second web forming step of forming a second web M8 from the mixture M7. The second web forming unit 19 has a mesh belt (separation belt) 191, stretching rollers 192, and a suction unit (suction mechanism) 193.

The mesh belt 191 is an endless belt and the mixture M7 is deposited thereon. The mesh belt 191 is wound around four stretching rollers 192. Then, the mixture M7 on the mesh belt 191 is transported to the downstream side by the rotational driving of the stretching rollers 192.

In addition, almost all of the mixture M7 on the mesh belt 191 is the size of the mesh opening of the mesh belt 191 or more. Due to this, the mixture M7 is restricted from passing through the mesh belt 191, and is thus able to be deposited on the mesh belt 191. In addition, the mixture M7 is transported to the downstream side together with the mesh belt 191 while being deposited on the mesh belt 191, and is thus formed as the layered second web M8.

The stretching rollers 192 are interconnected to a drive unit (not shown) having a driving source such as a motor, a transmission, and the like and are able to rotate at a predetermined rotation speed through the operation of the drive unit. The operation of the drive unit is controlled by the control unit 28 and, for example, it is also possible to set the rotation speed of the stretching rollers 192 to be variable, in particular, to set the rotation speed at multiple stages or without stages.

It is possible for the suction unit 193 to suction air from below the mesh belt 191. Due to this, it is possible to suction the mixture M7 on the mesh belt 191, that is, the second web M8, downward, thus, it is possible to promote the deposition of the mixture M7 on the mesh belt 191 and to promote the adjustment of the thickness of the second web M8 described below.

A pipe 246 is coupled to the suction unit 193. In addition, the blower 263 is installed in the middle of the pipe 246. The operation of the blower 263 makes it possible to generate a suction force at the suction unit 193. The operation of the blower 263 is controlled by the control unit 28.

A part of the mixture M7 which passed through the mesh belt 191 due to the air flow suctioned by the suction unit 193 is returned to the upstream path (not shown) by the air flow of the blower 263 and supplied, for example, into the pipe 241 or the housing portion 162, which makes re-use possible.

As described above, the fiber molded article manufacturing apparatus 10 has the suction unit 193 which suctions the second web M8 (the deposition) on the mesh belt 191 via the mesh belt 191. Due to this, it is possible to promote the deposition of the mixture M7 on the mesh belt 191 and to promote the adjustment of the thickness of the second web M8 described below. In addition, the random orientation of the fibers and the dispersibility of the mixture M7 on the mesh belt 191 are substantially maintained.

Selecting the mesh openings of the mesh belt 191, adjusting the suction strength of the suction unit 193, and the like make it possible to finely adjust the size of the fibers in the mixture M7 passing through the mesh belt 191, in particular, the average fiber length of the fibers, in a more appropriate range. Due to this, it is possible to make the size of the fibers in the constituent material of the fiber molded article 3, in particular, the average fiber length of the fibers, closer to the appropriate value as described above.

A humidifying unit 254 is coupled to the housing portion 182. The humidifying unit 254 is formed of a vaporization type humidifier similar to the humidifying unit 251. Due to this, humidified air is supplied into the housing portion 182. The humidified air makes it possible to humidify the inside of the housing portion 182 and, thus, it is also possible to suppress the mixture M7 from attaching to the inner wall of the housing portion 182 due to electrostatic force.

The humidifying unit 256 is arranged on the downstream side of the loosening unit 18. The humidifying unit 256 is formed of an ultrasonic humidifier similar to the humidifying unit 255. Due to this, it is possible to supply water to the second web M8, and thus to adjust the water content of the second web M8. This adjustment makes it possible to suppress the cling of the second web M8 to the mesh belt 191 due to electrostatic force. Due to this, the second web M8 is easily peeled off from the mesh belt 191 at a position where the mesh belt 191 is folded back by the stretching rollers 192.

The amount of water (total amount of water) added to the humidifying unit 251 to the humidifying unit 256 is, for example, preferably 0.5 parts by mass or more and 20 parts by mass or less with respect to 100 parts by mass of the material before humidification.

The sheet forming unit 20 is arranged on the downstream side of the second web forming unit 19. The sheet forming unit 20 is a portion which performs a sheet forming step of forming the sheet S from the second web M8. The sheet forming unit 20 has a pressing unit 201 and a heating unit 202 which perform the pressing and molding of the sheet S, and a cutting unit 205 which cuts the sheet S into a desired size.

The pressing unit 201 has a pair of calendar rollers 203 each arranged at the upper and lower sides to pinch the transport path of the second web M8, and the second web M8 is pressed between the calendar rollers 203. In such a case, the second web M8 is pressed without heating, that is, without melting the resin P included therein. Due to this, the second web M8 is compressed in the thickness direction to increase the density. Then, the second web M8 which passed through the pressing unit 201 is transported toward the heating unit 202. One of the pair of calendar rollers 203 is a main driving roller driven by the operation of a motor (not shown), and the other is a driven roller.

The heating unit 202 has a pair of heating rollers 204 each arranged at the upper and lower sides to pinch the transport path of the second web M8, and presses the second web M8 between the heating rollers 204 while carrying out heating. By this heating and pressing, the resin P is melted in the second web M8 and the fibers are bonded together via the melted resin P. Due to this, the sheet S is formed. It is sufficient if the sheet S has a higher shape retaining property in comparison with the second web M8. Accordingly, the resin P in the second web M8 may be in a state in which all or part of the resin P is in a semi-molten state, or a state in which the fibers are not completely bonded, other than a case in which the fibers are completely melted, solidified, and bonded together. This state is referred to below as a “temporary bonding state”. Here, one of the pair of heating rollers 204 is a main driving roller driven by the operation of a motor (not shown), and the other is a driven roller.

The sheet S obtained through the heating unit 202 is transported toward the cutting unit 205 arranged on the downstream side.

The cutting unit 205 is a portion which performs a cutting step of cutting the sheet S into a predetermined length (size). The cutting unit 205 has a pair of cutting blades 206 each arranged at the upper and lower sides to pinch the sheet S transport path. Both cutting blades 206 operate to approach and separate to cut the sheet S in a direction crossing, in particular, orthogonal to, the transport direction. Both cutting blades 206 operate at a predetermined timing corresponding to the transport speed of the sheet S to cut the sheet S into a desired length. Although not shown, the width of the sheet S may be adjusted to a desired length by cutting the sheet S in a direction parallel to the transport direction. In such a case, one end and the other end in the width direction of the sheet S are cut and removed to adjust the sheet S to a desired width. As described above, the sheet S is molded by the sheet forming unit 20.

In the fiber molded article manufacturing apparatus 10, the cutting unit 205 and each portion on the downstream side perform a step of forming a sheet.

The first molding unit 21 is arranged on the downstream side of the cutting unit 205. The first molding unit 21 is a portion that performs a step of molding the fiber molded article 3 from the sheet S.

The sheet S adjusted to a desired size by the cutting unit 205 is transported to the first molding unit 21. The first molding unit 21 has a lower mold 215 and an upper mold 216. The lower mold 215 is formed with a recessed cavity corresponding to the shape of the fiber molded article 3 to be manufactured, and the upper mold 216 is formed with a convex shape corresponding to the cavity. The lower mold 215 and the upper mold 216 are formed of, for example, a metal material. In addition, a ring-shaped heater 217 is incorporated in the lower mold 215 and the upper mold 216, and is able to perform heating at the time of molding. In the case of heating, the heating temperature is a temperature which is the softening point or melting point or higher of the resin P included in the sheet S, that is, the binder, and is, for example, approximately 60° C. or higher and 180° C. or lower.

The sheet S is inserted between the lower mold 215 and the upper mold 216 and the sheet S is heated and pressed by the lower mold 215 and the upper mold 216 while being heated to a temperature which is the melting point of the resin P or higher to mold the first structure 3A having the recess 31.

By carrying out the molding while heating, the binder melts and deforms, thus, it is possible to follow the deformation of the fibers and to more effectively prevent wrinkles and tears which occur at the time of molding.

In addition, as described above, since the content of the binder in the constituent material of the sheet S is 20% by weight or more and 40% by weight or less, it is possible to prevent wrinkles or tears occurring at the time of molding while favorably bonding the fibers without unevenness. In addition, the obtained first structure 3A has sufficient strength and appropriate rigidity.

The pressing force of the lower mold 215 at the time of molding, that is, the molding load, is preferably 100 kgf or more and 20000 kgf or less, and more preferably 300 kgf or more and 10000 kgf or less. Due to this, it is possible to more reliably obtain the effects of the present disclosure.

In addition, the pressure applied to the sheet S at the time of molding, that is, the molding pressure, is preferably 0.1 kgf/cm² or more and 100 kgf/cm² or less, and more preferably 0.1 kgf/cm² or more and 100 kgf/cm² or less. Due to this, it is possible to more reliably obtain the effects of the present disclosure.

The molding pressure may be constant throughout the fiber molded article 3 or may be partially different. For example, the pressure may be partially increased at a portion such as the bottom portion where relatively high rigidity is required.

In addition, after passing through this step, the first structure 3A is released from the lower mold 215 and the upper mold 216 and cooled.

In addition, heating may be omitted at the time of molding in the first molding unit 21. Due to this, it is possible to omit the step of cooling and to increase the productivity. Furthermore, it is possible to secure the flexibility of the inner wall surface of the first structure 3A. As a result, for example, even when housing a mirror-finished article, it is possible to prevent noticeable scratches. In such a case, forming the lower mold 215 and the upper mold 216 of, for example, chemical wood, makes it possible to more remarkably exhibit the effects described above.

As described above, in the method of manufacturing a fiber molded article, a step of forming a sheet by pressing a web formed of a material including fibers and a binder which bonds the fibers together, in which a content of the binder in the constituent material is 20% by weight or more and 40% by weight or less, and a step of molding a first structure with a shape having a recess with an average drawing depth of 10 mm or more and 150 mm or less, by pressing the sheet at least once are carried out. Due to this, it is possible to prevent wrinkles and tears which occur at the time of molding of the first structure 3A, while uniformly bonding the fibers without unevenness. In addition, the obtained first structure 3A has a sufficient strength and appropriate rigidity.

### Second Embodiment

FIG. 2 is a view showing a second embodiment of a manufacturing apparatus and manufacturing steps for carrying out the method of manufacturing a fiber molded article of the present disclosure. A description will be given below of the second embodiment while referring to FIG. 2; however, the description will focus on the difference with the first embodiment described above and the same points will be omitted from the description.

As shown in FIG. 2, in the present embodiment, the fiber molded article 3 has the first structure 3A described above and a second structure 3B filled in the recess 31. The second structure 3B has a lower density than the first structure 3A. Due to this, the buffer action is greater than that of the first structure 3A, and the second structure 3B is excellent as a buffer material. For example, inserting an article into the recess 31 so as to press into the second structure 3B makes it possible to bring the article and the second structure 3B into close contact to protect the article.

In addition, the second structure 3B is formed of the same material as the constituent material of the first structure 3A described above. Due to this, it is possible to easily perform the filling step described below and to simplify the apparatus configuration.

The density of the constituent material in the second structure 3B is preferably 0.01 g/cm³ or more and 0.3 g/cm³ or less, and more preferably 0.02 g/cm³ or more and 0.2 g/cm³ or less. Due to this, it is possible to sufficiently exhibit the buffer action described above.

Next, a description will be given of the fiber molded article manufacturing apparatus 10 in the present embodiment.

As shown in FIG. 2, the fiber molded article manufacturing apparatus 10 further has an deposition unit 22 provided on the downstream side of the first molding unit 21, and a second molding unit 23 provided on the downstream side of the deposition unit 22.

The deposition unit 22 is a portion which performs an deposition step and has a function of dispersing the mixture M7 in the air. It is possible to form the deposition unit 22 with, for example, the same configuration as the loosening unit 18 described in the above embodiment. In addition, the deposition unit 22 communicates with the drum unit 181 of the loosening unit 18 by a pipe 220. Due to this, the same material as the constituent material of the first structure 3A, that is, the mixture M7 is supplied to the deposition unit 22.

The lower mold 215 moves to the downstream side, that is, the lower side of the deposition unit 22, in a state in which the first structure 3A molded by the first molding unit 21 is housed. Due to this, the mixture M7 dispersed in the air from the deposition unit 22 is deposited in the recess 31 of the first structure 3A, and a third web M9 is formed in the recess 31.

Thus, the deposition unit 22 performs an deposition step of depositing the third web M9 formed of the same material as the constituent material of the first structure 3A.

The second molding unit 23 has a heating plate 231 which is able to move up and down. The heating plate 231 incorporates a ring-shaped heater 230. The heating temperature of the heating plate 231 is set to the temperature of the softening point or the melting point or higher of the resin P included in the third web M9, that is, the binder, and is set to, for example, approximately 60° C. or higher and 180° C. or lower.

The lower mold 215 moves below the heating plate 231 in a state in which the first structure 3A is housed in a state in which the third web M9 is deposited in the recess 31 in the deposition unit 22. Then, the heating plate 231 moves down and contacts the upper surface of the third web M9. Due to this, the binder in the vicinity of the surface of the third web M9 is melted and the fibers are bonded to each other. Thus, it is possible to prevent the third web M9 from partially protruding or separating from the recess 31. Furthermore, the binder at the upper end portion of the first structure 3A also melts and bonds with the fibers or binder of the third web M9. Due to this, the first structure 3A and the third web M9 are partially bonded to each other, and the third web M9 is prevented from being separated from the inside of the recess 31. The third web M9 partially bonded to the first structure 3A is the second structure 3B.

In this manner, the method of manufacturing a fiber molded article according to the present embodiment has a step of depositing the third web M9 formed of the constituent material of the first structure 3A in the recess 31 of the first structure 3A, and a step of forming the third web M9 by heating in the recess 31. Due to this, it is possible to mold the second structure 3B filled in the recess 31. As a result, the fiber molded article 3 is particularly excellent as a buffering material.

### Third Embodiment

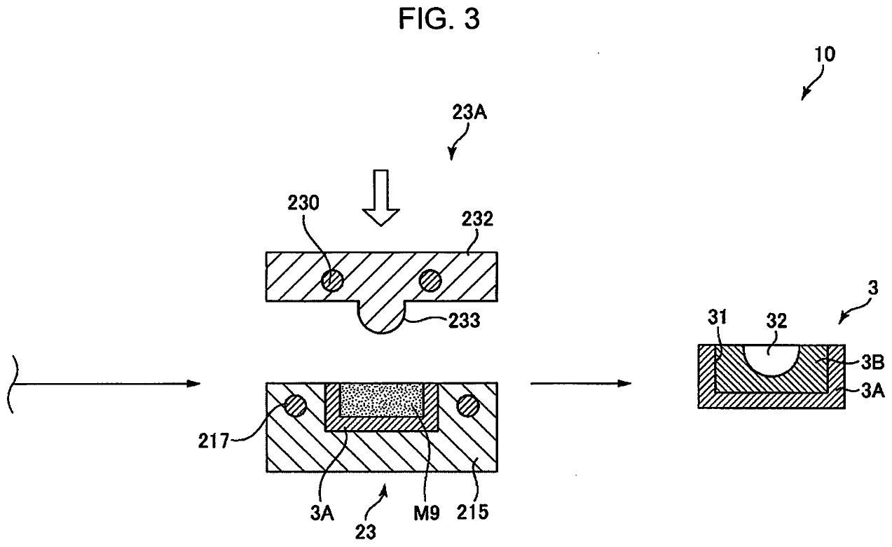

FIG. 3 is a view showing a third embodiment of a manufacturing apparatus and manufacturing steps for carrying out the method of manufacturing a fiber molded article of the present disclosure. A description will be given below of the third embodiment while referring to FIG. 3; however, the description will focus on the difference with the second embodiment described above and the same points will be omitted from the description.

The present embodiment is the same as the second embodiment except that the configuration of the second molding portion is different.

As shown in FIG. 3, in the present embodiment, a heating plate 232 of a second molding unit 23A has a protrusion 233 at the center portion of the lower surface thereof. The protrusion 233 is smaller than the recess 31 in a plan view of the heating plate 232. In addition, the end portion on the lower side of the protrusion 233 is rounded.

In the second molding unit 23A, when the heating plate 232 moves down and contacts the upper surface of the third web M9, the protrusion 233 enters the third web M9. For this reason, a hollow 32 of the shape corresponding to the protrusion 233 is formed in the surface of the third web M9.

In the fiber molded article 3 above, the hollow 32 functions as a positioning portion when storing an article. In addition, the density of the constituent material in the second structure 3B is lower than the density of the constituent material in the first structure 3A, preferably 0.03 g/cm³ or more and 0.4 g/cm³ or less, more preferably 0.04 g/cm³ or more and 0.3 g/cm³ or less. Due to this, it is also possible to sufficiently exhibit the buffer action described above.

As described above, in the present embodiment, in the step of heating the third web M9, the third web M9 in the recess 31 is molded, that is, heating and pressing are performed. Due to this, for example, it is possible to apply a functional unit such as the positioning unit described above to the second structure 3B.

### Fourth Embodiment

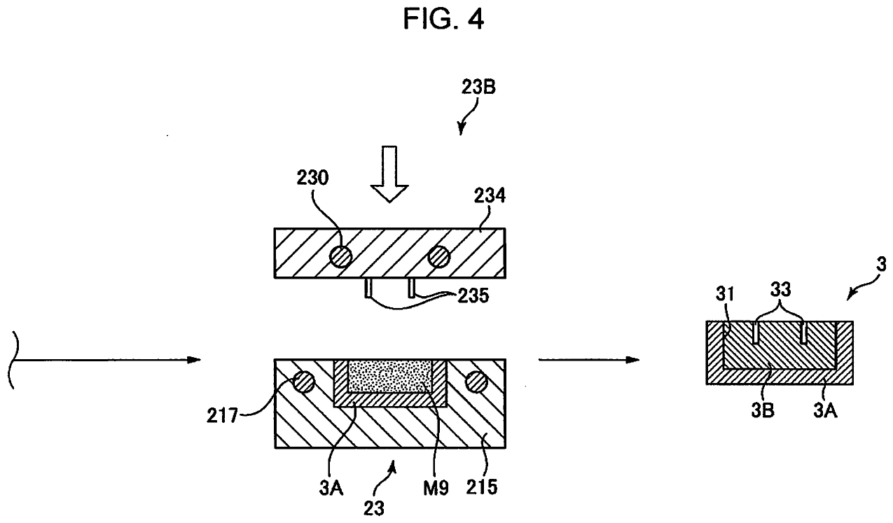

FIG. 4 is a view showing a fourth embodiment of a manufacturing apparatus and manufacturing steps for carrying out the method of manufacturing a fiber molded article of the present disclosure. A description will be given below of the fourth embodiment while referring to FIG. 4; however, the description will focus on the difference with the second embodiment described above and the same points will be omitted from the description.

The present embodiment is the same as the second embodiment except that the configuration of the deposition unit is different.

As shown in FIG. 4, in the present embodiment, a heating plate 234 of a second molding unit 23B has a pair of ribs 235 at the center portion of the lower surface thereof. The separation distance between each of the ribs 235 in a plan view of the heating plate 234 is smaller than the width of the recess 31, that is, the length in the left-right direction of paper surface.

In the second molding unit 23B, when the heating plate 234 moves down and contacts the upper surface of the third web M9, the pair of the ribs 235 enter the third web M9. Therefore, a pair of slits 33 having a shape corresponding to the pair of the ribs 235 is formed on the surface of the third web M9.

In the fiber molded article 3, the portion between the slits 33 of the second structure 3B tends to collapse first. Due to this, it is possible to more effectively exhibit the function as a shock absorbing material.

### Fifth Embodiment

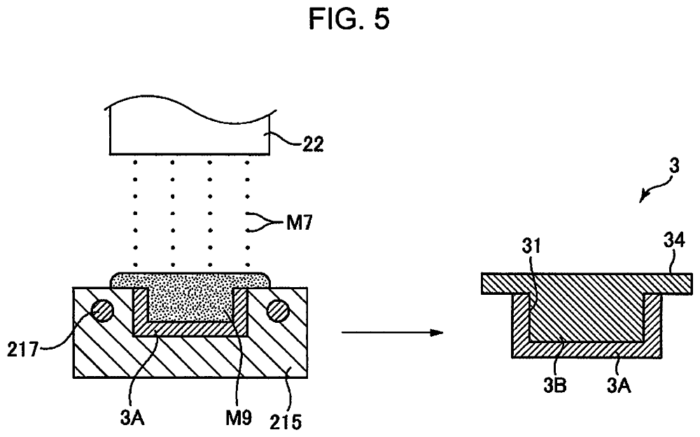

FIG. 5 is a view showing a fifth embodiment of a manufacturing apparatus and manufacturing steps for carrying out the method of manufacturing a fiber molded article of the present disclosure. A description will be given below of the fifth embodiment with reference to FIG. 5; however, the description will focus on the difference with the first embodiment described above and the same points will be omitted from the description.

The present embodiment is the same as the second embodiment except that the configuration of the second molding portion is different.

As shown in FIG. 5, in the present embodiment, the deposition unit 22 disperses the mixture M7 such that the mixture M7 is also deposited in the recess 31 and on the upper surface of the lower mold 215. For example, by relatively increasing the diameter of the opening of the housing of the deposition unit 22 and the diameter of the drum unit with respect to the lower mold 215, it is also possible to deposit the mixture M7 on the upper surface of the lower mold 215.

In this state, for example, by molding the third web M9 in the same manner as in the second embodiment, a flange 34 is formed at the second structure 3B. The flange 34 is a plate formed to protrude in the direction intersecting the drawing depth direction of the recess 31.

It is possible for this flange 34 to function as a coupling portion with other fiber molded articles 3, that is, as a coupling margin. In addition, for example, due to further processing such as bending the flange 34, the flange 34 may also function as a positioning portion for articles to be stored.

The fiber molded article and the method of manufacturing a fiber molded article of the present disclosure was described based on each illustrated embodiment; however, the present disclosure is not limited thereto and it is possible to replace each portion forming the fiber molded article with any configuration which is able to perform the same function. In addition, any component may be added thereto. In addition, any configuration may be added before and after each step to the method of manufacturing a fiber molded article.

In addition, the fiber molded article and the fiber molded article manufacturing apparatus may combine of any two or more configurations (characteristics) of the respective embodiments described above.

### EXAMPLES

Next, a description will be given of specific Examples of the present disclosure.

### Example 1

### [1] Manufacturing of Fiber Molded Article

Waste paper including cellulose as fibers was introduced into the raw material supply unit 11 of the fiber molded article manufacturing apparatus 10 shown in FIG. 1 to obtain a first structure, that is, a fiber molded article. In addition, the resin supplied by the resin supply unit 171, that is, the binder, was polyethylene.

In addition, in the first molding unit 21, the heating temperature was 150° C. and the molding pressure was 20 kgf/cm².

In the constituent material of the fiber molded article, the content of the fibers and the content of the binder were as shown in Table 1. In addition, the average fiber length of the fibers was 1.1 mm and the average fiber width of the fibers was 12 μm. In addition, the average particle diameter of the particles of the binder was 20 μm.

In addition, in the obtained fiber molded article, the average depth of the recesses 31 is 100 mm, the volume of the recesses 31 is 250 cm³, the average thickness is 0.5 mm, and the density of the constituent material is 1.2 g/cm³.

### Examples 2 and 3

A fiber molded article was manufactured in the same manner as in Example 1 except that the fiber content and the binder content were changed as shown in Table 1.

### Comparative Examples 1 to 3

A fiber molded article was manufactured in the same manner as in Example 1 except that the fiber content and the binder content were changed as shown in Table 1.

### [2] Evaluation

### 2. Evaluation of Moldability

The obtained fiber molded article was visually confirmed to confirm whether wrinkles or tears occurred, and evaluation was carried out as follows.

A: No wrinkles or tears occurred.

B: Only slight wrinkles occurred.

C: Slight wrinkles and tears occurred.

D: Wrinkles and tears were noticeable.

These results are summarized in Table 1 below.

TABLE 1

| | | | | | Comparative | Comparative | Comparative |
|---|---|---|---|---|---|---|---|
| | | Example 1 | Example 2 | Example 3 | Example 1 | Example 2 | Example 3 |
| Fibers | Content (% by | 80 | 70 | 60 | 87 | 85 | 50 |
| | weight) | | | | | | |
| Binder | Content (% by | 20 | 30 | 40 | 13 | 15 | 50 |
| | weight) | | | | | | |
| Evaluation | Moldability | A | A | A | D | C | D |

As is apparent from Table 1, the fiber molded articles of the respective examples of the present disclosure were excellent in the moldability in comparison with the fiber molded articles of each of the Comparative Examples.

What is claimed is:

1. A fiber molded article comprising:
a first structure that is formed of a material including fibers and a binder which bonds the fibers together and that has a shape which has a recess where an average drawing depth is 10 mm or more and 150 mm or less, wherein
a content of the binder in the material is 20% by weight or more and 40% by weight or less.

2. The fiber molded article according to claim 1, wherein
an average fiber length of the fibers is 0.5 mm or more and 2.0 mm or less.

3. The fiber molded article according to claim 1, wherein
an average fiber width of the fibers is 5 μm or more and 50 μm or less.

4. The fiber molded article according to claim 1, wherein
the binder is in a form of particles with an average particle diameter of 1 μm or more and 500 μm or less.

5. The fiber molded article according to claim 1, wherein
a density of the material in the first structure is 0.5 g/cm³ or more and 2.0 g/cm³ or less.

6. The fiber molded article according to claim 1, further comprising:
a second structure that is filled in the recess and that has a lower density than the first structure.

7. The fiber molded article according to claim 6, wherein
a density of the material in the second structure is 0.01 g/cm³ or more and 0.3 g/cm³ or less.

8. The fiber molded article according to claim 6, wherein
the second structure is formed of the material.

9. A method of manufacturing a fiber molded article, the method comprising:
forming a sheet by pressing a web formed of a material including fibers and a binder which bonds the fibers together, in which a content of the binder in the material is 20% by weight or more and 40% by weight or less; and
molding a first structure with a shape having a recess with an average drawing depth of 10 mm or more and 150 mm or less, by pressing the sheet at least once.

10. The method of manufacturing a fiber molded article according to claim 9, further comprising:
depositing the web formed of the material in the recess; and
heating and forming the web in the recess.

11. The method of manufacturing a fiber molded article according to claim 9, wherein
the heating of the web includes carrying out molding on the web in the recess.
